(19) United States
(12) Patent Application Publication
(10) Pub. No.: US 2021/0398375 A1
(43) Pub. Date: Dec. 23, 2021

(54) ELECTRONIC KEY MANAGEMENT SYSTEM AND SERVER

(71) Applicant: PLATFORMBASE CO., LTD, Suwon-si, Gyeonggi-do (KR)

(72) Inventor: Bum Soo KIM, Namyangju-si, Gyeonggi-do (KR)

(21) Appl. No.: 17/281,573

(22) PCT Filed: Nov. 2, 2020
(86) PCT No.: PCT/KR2020/015174

§ 371 Date: Mar. 30, 2021

(30) Foreign Application Priority Data
Nov. 1, 2019 (KR) 10-2019-0138472
Nov. 2, 2020 (KR) 10-2020-0144720

(51) Int. Cl. G07C 9/21; G07C 9/22; G07C 9/27; G07C 9/00; E05B 49/00

(52) U.S. Cl. CPC G07C 9/21; G07C 9/22; G07C 9/27; G07C 2209/62; E05B 49/002; G07C 2009/00238; G07C 9/00182

(57) ABSTRACT

Provided are an electronic key management system and a server. The electronic key management system includes: an electronic key configured to lock and unlock an electronic locking device; an electronic key storage device configured to include a plurality of key holes and a key holder fastened with an electronic key carried into the key hole, and control the key holder according to a preset electronic key access right; a management server configured to set an access right to the electronic locking device of the electronic key, transmit a one-time authentication ID to the electronic key that is put into the electronic locking device and electrically connected to the electronic locking device, and receive log information of the electronic key on the electronic locking device in real time; and a user terminal configured to transmit and receive the log information and the one-time authentication ID between the electronic key and the management server, and display real-time log information.

### TECHNICAL FIELD

The present disclosure relates to an electronic key management system and a server.

### BACKGROUND ART

Locking devices installed for security on entrance doors, lockers, facilities, etc., may be largely classified into mechanical locking devices and electronic locking devices. In the case of a mechanical locking device that opens and closes an entrance door, a locker, etc., using a key, there is a problem of having to replace the locking device when the key is lost, along with security problems due to manipulation or storage of the key.

In view of this, the electronic locking device that opens and closes a door using a password, a user's fingerprint and voice or an electronic key has been frequently used. Since there is no fear of losing keys, general users may easily open and close doors and lockers through simple authentication, and security is excellent, the market for the electronic locking devices is rapidly growing in recent years.

Therefore, when the plurality of electronic locking devices is installed in a plurality of locations, an electronic key management system is required to prevent loss by storing a plurality of electronic keys and to efficiently manage the electronic keys.

### DISCLOSURE

### Technical Problem

The technical problem to be solved by the present disclosure is to provide an electronic key management system and a server capable of efficiently and stably managing an electronic key.

Objects of the present disclosure are not limited to the object(s) mentioned above, and other object(s) that are not mentioned may be obviously understood by those skilled in the art from the following description.

### Technical Solution

According to an aspect, an electronic key management system includes: an electronic key configured to lock and unlock an electronic locking device; an electronic key storage device configured to include a plurality of key holes and a key holder fastened with an electronic key carried into the key hole, and control the key holder according to a preset electronic key access right; a management server configured to set an access right to the electronic locking device of the electronic key, transmit a one-time authentication ID to the electronic key that is put into the electronic locking device and electrically connected to the electronic locking device, and receive log information of the electronic key on the electronic locking device in real time; and a user terminal configured to transmit and receive the log information and the one-time authentication ID between the electronic key and the management server, and display real-time log information.

In one embodiment, the management server may transmit one-time authentication data corresponding to the one-time authentication ID to the electronic locking device through the electronic key.

In one embodiment, the management server may store any one or more of location information of the plurality of electronic locking devices and current state information of the electronic locking device, and display the location information and the current state information through a display unit.

In one embodiment, the management server may display locations of the electronic locking devices into which the electronic key without unlocking authority is put on the display unit on which the locations of the plurality of electronic locking devices are displayed, differently from other electronic locking devices.

In one embodiment, the management server may transmit the one-time authentication ID corresponding to the one-time authentication data to the electronic locking device into which the electronic key without the unlocking authority displayed on the display unit differently from the other electronic locking devices is put and the put electronic key, respectively, when an administrator's approval is input.

In one embodiment, the electronic key may delete the one-time authentication ID after receiving the one-time authentication ID and unlocking the electronic locking device.

In one embodiment, the management server may transmit a message notifying an unlocking attempt without unlocking authority from the electronic locking device to a pre-registered user terminal of a user with unlocking authority when the unlocking attempt by the electronic key without the unlocking authority is confirmed.

According to another aspect, an electronic key management server includes: a communication unit configured to transmit and receive an electronic key and information; a storage unit configured to store log information received from the electronic key; and a control unit configured to set an access right to an electronic locking device of the electronic key, and set a one-time authentication authority for the electronic key that is put into the electronic locking device and electrically connected to the electronic locking device, in which the control unit controls to transmit a one-time authentication ID generated according to the one-time unlocking authority setting to the electronic key.

In one embodiment, the storage unit may store locations of a plurality of electronic locking devices, and may further include a display unit for displaying at least one of current state information of the electronic locking device received through the communication unit and a location of the electronic locking device.

In one embodiment, the control unit may set an authentication authority of the electronic key, and the authentication authority may include at least one of a date, a time, and a day of the week in which authentication execution is possible.

### Advantageous Effects

The effects according to the present disclosure are as follows.

It is possible to easily manage the query of the use history of the electronic key, and the setting of the authentication authority, and the like by using the electronic key management system proposed in the present disclosure. As a result, it is possible to improve user convenience and security.

In addition, it is possible to systematically manage the electronic keys using the electronic key storage device when it is necessary to store the plurality of keys, and easily perform the charging of the electronic keys and the collection of the use history (log information) during the process.

The effects of the present disclosure are not limited to the above-mentioned effects, and other effects that are not mentioned may be obviously understood by those skilled in the art from the following description.

### DESCRIPTION OF DRAWINGS

FIG. 1 is a block diagram schematically illustrating a configuration of an electronic key management system used in an embodiment of the present disclosure.

FIG. 2 is a diagram schematically illustrating a configuration of a electronic locking device according to an embodiment of the present disclosure.

FIG. 3 is a block diagram schematically illustrating a configuration of an electronic key according to an embodiment of the present disclosure.

FIG. 4 is a block diagram illustrating a configuration of a user terminal according to an embodiment of the present disclosure.

FIG. 5 is a block diagram illustrating a configuration of a management server according to an embodiment of the present disclosure.

FIG. 6 is a block diagram schematically illustrating a configuration of an electronic key management system according to another embodiment of the present disclosure.

FIG. 7 is a diagram illustrating an example of a screen displayed by the management server according to an embodiment of the present disclosure.

FIG. 8 is a diagram illustrating an example of a screen displayed by the user terminal according to an embodiment of the present disclosure.

### BEST MODE

Since the present disclosure may be variously modified and have several exemplary embodiments, specific exemplary embodiments will be illustrated in the accompanying drawings and be described in detail in a detailed description. However, this is not intended to limit the present disclosure to specific embodiments, and can be understood to include all conversions, equivalents, or substitutes included in the technical spirit and technical scope of the present disclosure. In describing each drawing, similar reference numerals are used for similar components.

The terms used in the present application are only used to describe specific embodiments, and are not intended to limit the present disclosure. Singular forms are intended to include plural forms unless the context clearly indicates otherwise. It will be further understood that the term “comprises” or “have” used in this specification, specifies the presence of stated features, numerals, steps, operations, components, parts mentioned in this specification, or a combination thereof, but do not preclude the presence or addition of one or more other features, numerals, steps, operations, components, parts, or a combination thereof.

Unless indicated otherwise, it is to be understood that all the terms used in the specification including technical and scientific terms have the same meaning as those that are generally understood by those who are skilled in the art. Terms generally used and defined by a dictionary should be interpreted as having the same meanings as meanings within a context of the related art and should not be interpreted as having ideal or excessively formal meanings unless being clearly defined otherwise in the present disclosure.

Hereinafter, preferred embodiments according to the present disclosure will be described in detail with reference to the accompanying drawings.

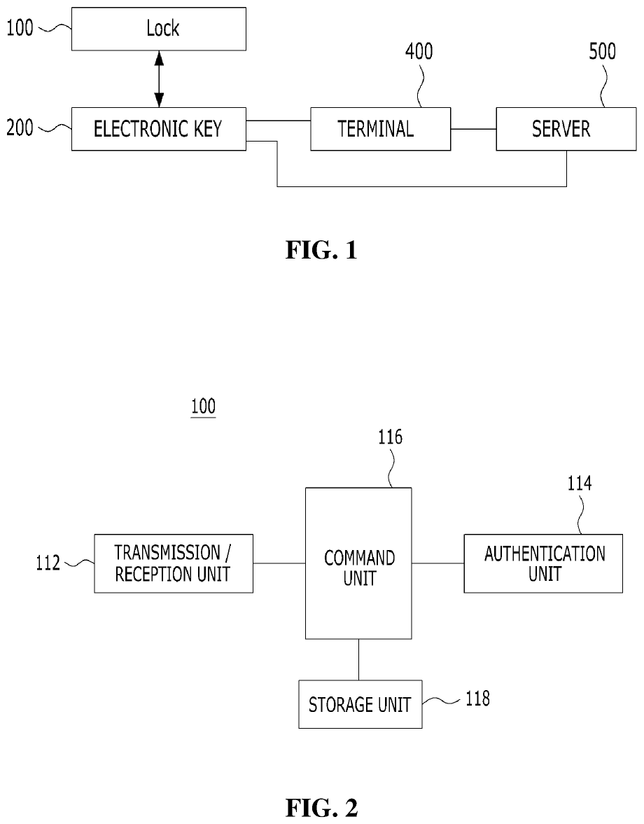

FIG. 1 is a block diagram schematically illustrating a configuration of an electronic key management system used in an embodiment of the present disclosure.

The electronic key management system may include a key 200, a user terminal 400, and a management server 500.

The electronic key 200 refers to a key for locking or unlocking an electronic locking device 100. The electronic key 200 collects a use history and transmits the collected use history to the authorized user terminal 400 and the management server 500.

Here, the electronic locking device 100 may be any one of a pad lock, a Europrofile double, a rim lock, a drawer lock, and a cam lock.

The user terminal 400 provides an electronic key management service by accessing the electronic key 200 and the management server 500 through a communication network.

The user terminal 400 is installed with an application for providing the electronic key management service, and the user may use the electronic key management service through the installed application. Here, the electronic key management service refers to various services that may improve convenience and security in the use of the electronic key 200, and includes log information (use history), authority setting, and the like. Here, the log information may be information on a time when the electronic key 200 is put into the electronic locking device 100 and is electrically connected to the electronic locking device 100 and authentication success/failure. Authority setting is to set any one or more of a date, a time, and a day of the week in which the electronic key 200 may perform authentication with the electronic locking device 100. Accordingly, the electronic key 200 may enable the electronic key to be activated only when the authority is set. The authority setting can be made through the user terminal 400 and/or the management server 500 as described later.

To this end, the user terminal 400 may be implemented as, for example, a smartphone, a PDA, a tablet PC, a notebook computer, a laptop computer, a personal computer, and electronic devices or similar devices capable of performing other communications, receiving user input, and outputting a screen.

The management server 500 receives and stores electronic key-related information from one or more user terminals 400 and/or electronic keys connected through a communication network, and provides various electronic key management services. In particular, the management server 500 may search, edit, delete, etc. stored information according to the request of the user terminal 400, and grant a one-time unlocking authority to the electronic key.

The management server 500 may be implemented as, for example, a workstation, a server, a general-purpose computer, an electronic device capable of performing other communication, or a similar device.

The communication network may be implemented using at least some of, for example, long term evolution (LTE), LTE-advanced (LTE-A), Wi-Fi, a local area network (LAN), a wide area network (WAN), code division multiple access (CDMA), time division multiple access (TDMA), wireless broadband (WiBro), and global system for mobile communications (GSM), and other communication methods developed in the past and present or available in the future. Hereinafter, for convenience, a communication network is not mentioned, and each component is described as if they directly communicate. In addition, each component may use different communication networks. For example, the electronic key 200 and the user terminal 400 may use a Wi-Fi communication method, and the user terminal 400 and the server may use the long term evolution (LTE) communication method.

FIG. 2 is a diagram schematically illustrating a configuration of the electronic locking device according to the embodiment of the present disclosure.

The electronic locking device 100 includes a transmission/reception unit 112, an authentication unit 114, a command unit 116, and a storage unit 118.

When the electronic key 200 is put into the electronic locking device 100 and electrically contacts with the electronic locking device 100, the transmission/reception unit 112 may receive unique ID (UID) data pre-stored in the electronic key 200 or a one-time authentication ID (for example, ID of the electronic locking device).

The authentication unit 114 performs authentication based on the UID data or the one-time authentication ID. When both the one-time authentication data and the UID data are retrieved, the authentication unit 114 performs the authentication using the one-time authentication data. Here, the UID data is data for common authentication, while the one-time authentication data is data for one-time authentication that is assigned one-time from the management server 500 according to an administrator's approval.

In one embodiment, the authentication unit 114 may compare the UID data pre-stored in the electronic key 200 with authentication data (for example, the UID of the electronic key) pre-stored in the electronic locking device 100, and perform the authentication on the UID data based on the comparison result.

That is, when it is determined that the UID data and the authentication data received from the electronic key 200 are the same, the authentication unit 114 may perform the authentication process on the UID data (authentication success), and when it is determined that the UID data and the authentication data are not the same, the authentication unit 114 may not process the approval for the UID data (authentication failure).

In another modification, the authentication unit 114 may perform primary authentication according to whether first authentication data pre-stored in the electronic key 200 is matched, further receive encrypted data input by a button provided in the electronic key 200, and determine whether pre-stored second authentication data is matched, thereby performing double authentication on the encrypted data.

The authentication unit 114 may store and manage all log information related to authentication of the UID data and the one-time authentication data.

Here, the log information may include, for example, log information on whether the electronic key 200 is authenticated, log information on an opening/closing time of the electronic locking device 100 by the authenticated electronic key 200, log information on registration or change of the master electronic key 200, and log information on registration or change of a blacklist according to whether the electronic key 200 is lost.

Here, when the electronic key 200 is lost, the blacklist may be registered or changed by allowing the management server 500 receiving loss information of the electronic key 200 from the user terminal to match and store the UID data related to the lost electronic key 200 with the loss information.

Specifically, when a user loses the electronic key 200, he/she may input the loss information of the electronic key 200 through the user terminal 400 and transmits the input loss information to the management server 500, and the management server 500 may register or change the blacklist by matching and storing the lost information with UID data related to the electronic key 200. Here, the user terminal 400 may correspond to the mobile communication terminal, and the loss information may include the UID data of the electronic key 200 and data on whether the electronic key 200 is lost.

When an attempt is made to unlock the electronic locking device 100 with the electronic key 200, the authentication unit 114 may receive the blacklist generated by the management server 500, from the electronic key 200, determine whether the electronic key 200 is registered in the blacklist, and maintain a locked state of the electronic locking device 100 when it is determined that the electronic key 200 is registered in the blacklist. In this case, the authentication unit 114 may transmit to the management server 500 as a notification message that the attempt has been made to unlock the electronic locking device 100 with the electronic key 200.

On the other hand, when the user obtains the lost electronic key 200, the user terminal 400 may transmit the acquisition information of the lost electronic key 200 to the management server 500. Accordingly, the management server 500 may change (delete) the blacklist corresponding to the acquired information.

Meanwhile, before the authentication unit 114 performs the authentication, the electronic key 200 may undergo a key activation operation.

For example, the electronic key 200 may receive a password generated by the application from the user terminal 400 through the wireless communication in the state in which the electronic key 200 is connected to the user terminal 400 on which an application for setting the input of the UID data is mounted before a terminal unit provided in a key head of the electronic key 200 electrically contacts with a data communication unit of the electronic lock device 100.

In this case, when a key value is input by a button provided on the electronic key 200, the electronic key 200 may determine whether the input key value matches the password, and may be activated when it is determined that the input key value matches the password.

That is, when the key value input by the user through the button is the same as the password received from the user terminal 400, the electronic key 200 may have a function of performing the authentication thereafter.

Alternatively, the electronic key 200 may have a default value for key activation provided therein before the terminal unit provided in the key head of the electronic key 200 electrically contacts with the data communication unit of the electronic locking device 100.

In this case, when a key value is input by a button provided on the electronic key 200, the electronic key 200 may determine whether the input key value matches the default value, and may be activated when it is determined that the input key value matches the default value. That is, when the key value input by the user through the button is the same as the default value, the electronic key 200 may have a function of performing the authentication thereafter.

In an embodiment of the present disclosure, it is described that the authentication unit 114 performs the key activation operation using the electronic key 200, but the present disclosure is not limited thereto. Therefore, the key activation operation may also be performed through biometrics using fingerprints, blood vessels, irises, and the like.

When the double authentication for the UID data and the encrypted data is successfully performed, the command unit 116 instructs the electronic locking device 100 to be unlocked.

That is, the command unit 116 may instruct the electronic locking device 100 to be opened after all the authentication for the UID data in the authentication unit 114 has passed. To this end, the command unit 116 may transmit a control signal related to unlocking to a driving unit of the electronic locking device 100.

On the other hand, when the authentication unit 114 fails to authenticate the UID data, the command unit 116 may instruct the electronic locking device 100 to maintain the locked state.

The storage unit 118 may store a list of identifiers (authentication data) of the electronic key 200 capable of locking and unlocking itself in an internal memory of the electronic locking device 100. As a result, according to an embodiment of the present disclosure, the electronic locking device 100 may perform authentication through authentication of the UID data, thereby improving the security efficiency of the electronic locking device 100.

On the other hand, according to an embodiment of the present disclosure, when the attempt is made to unlock the electronic locking device 100 from the outside, information on who has accessed the management server 500 of the electronic locking device 100 may be transmitted.

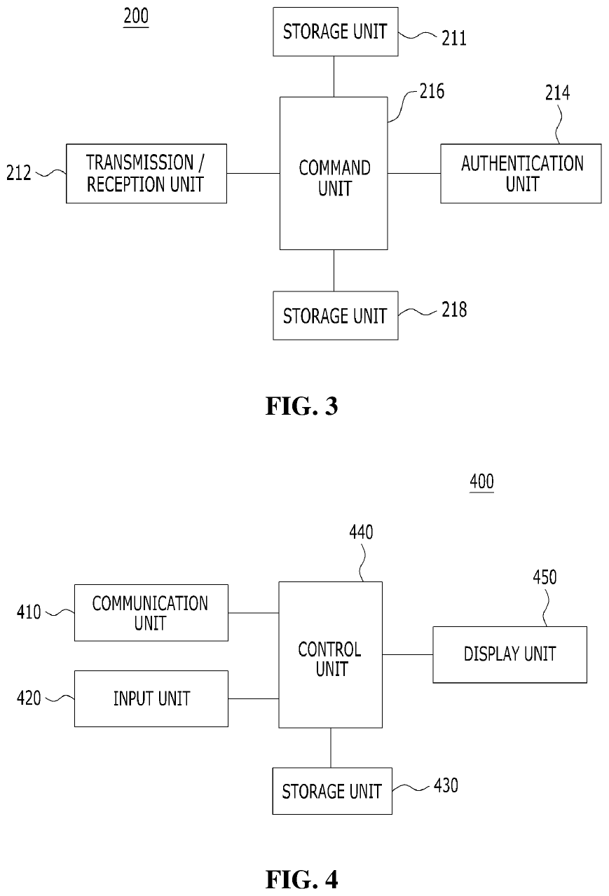

FIG. 3 is a block diagram schematically illustrating a configuration of the electronic key according to the embodiment of the present disclosure.

Referring to FIG. 3, the electronic key 200 includes a communication unit 211, a transmission/reception unit 212, an authentication unit 214, a control unit 216, and a storage unit 218.

The communication unit 211 may include a module that transmits and receives information through a local area network such as Bluetooth. The communication unit 211 may be connected to the user terminal 400 and the management server 500 by wire or wirelessly to transmit log information L to the user terminal 400 and/or the management server 500.

However, since the electronic key 200 has a limitation in adding a communication module due to its volume constraint, when only a short-range communication module such as Bluetooth is added to the electronic key 200, the electronic key 200 may communicate with the management server 500 using the user terminal 400 without directly communicating with the management server 500.

In an embodiment, the communication unit 211 may be wirelessly connected to the user terminal 400 by performing a pairing operation with the user terminal 400 through Bluetooth.

The communication unit 211 may receive a key access right from the user terminal 400 or the management server 500. For example, the communication unit 211 may receive and store authentication data, such as UID data, one-time UID data, and one-time authentication data, for unlocking the electronic key from the user terminal 400 or the management server 500.

In addition, the communication unit 211 may transmit the key use history (log information) to the user terminal 400 or the management server 500 in real time.

The transmission/reception unit 216 may receive the unique ID (UID) data pre-stored in the electronic locking device 100 when the electronic key 200 is put into the electronic locking device 100 and electrically contacts with the electronic locking device 100, and may transmit the pre-stored UID or one-time authentication ID stored in advance in the electronic key 200 to the electronic locking device 100. In addition, when the electronic key 200 stores the one-time authentication data, the transmission/reception unit 216 may transmit the one-time authentication data in preference to other data when the electronic key 200 is put into the electronic locking device 100 and electrically contacts with the electronic locking device 100. The one-time authentication ID may be deleted when the contact with the electronic locking device 100 is cut off.

The authentication unit 214 performs authentication based on the UID data or the one-time authentication ID. When both the one-time authentication data and the UID data are retrieved, the authentication unit 214 performs the authentication using the one-time authentication data.

The control unit 216 controls the communication unit 211 and the storage unit 218 to perform electronic key authentication and management.

When the control unit 216 is put into the electronic locking device 100 and electrically contact with the electronic locking device 100, the contact time and the authentication success or failure may be stored in the storage unit 218 to database the key use history.

When the control unit 216 is put into the electronic locking device 100 and electrically contacts with the electronic locking device 100 to perform the authentication with the electronic locking device 100, the control unit 216 uses the one-time UID data to perform the authentication with the electronic locking device 100 when the one-time UID data is received directly from the management server 500 or through the user terminal 400.

In an embodiment, the control unit 216 may store and manage information related to the authentication of the UID data and the one-time data during the authentication.

Meanwhile, before the authentication unit 214 performs the authentication, the electronic key 200 may undergo the key activation operation. Since the key activation operation is the same as the operation described in FIG. 2, a detailed description thereof will be omitted.

In another embodiment of the present disclosure, it is described that the authentication unit 214 performs the key activation operation using the electronic key 200, but the present disclosure is not limited thereto. Therefore, the key activation operation may also be performed through biometrics using fingerprints, blood vessels, irises, and the like.

When the UID data is successfully authenticated, the control unit 216 instructs the electronic locking device 100 to be unlocked.

Here, the unlocking command of the control unit 216 is the same or similar to the method performed by the command unit 116 of the electronic locking device 110 according to an embodiment of the present disclosure. As a result, in other embodiments of the present disclosure, a description thereof will be omitted.

Meanwhile, the electronic key 200 may further include a battery. The battery may be a recharging type. As will be described later in FIG. 6, the battery of the electronic key 200 may be charged by the key storage device.

As described above, in another embodiment of the present disclosure, by performing the authentication using the UID data based on the wireless communication between the electronic key 200 and the user terminal 400, the electronic locking device may be unlocked by a simple and convenient authentication method, and furthermore, the security efficiency of the electronic locking device 110 may be improved. In addition, in another embodiment of the present disclosure, by performing the authentication using the one-time data based on the wireless communication between the electronic key 200 and the user terminal 400, the access right to the electronic locking device 100 may be easily controlled by the management server 500.

The electronic locking device 100 does not have a separate power supply, and temporarily receives power from the connection terminal of the electronic key 200 through the connection terminal and thus unlocks the electronic locking device 100. In this case, the connection terminal of the electronic locking device 100 and the connection terminal of the electronic key 200 may be in physical contact with each other to supply power as well as exchange identifiers (UIDs) of each other, thereby performing the primary authentication.

As a result, it is possible to lock and unlock the plurality of electronic locking devices 100 with one electronic key 200. That is, the list of the identifiers of the electronic key 200 that may lock and unlock itself is stored in the internal memory of the electronic locking device 100, and the list of the identifiers of the electronic locking device 100 that may be locked and unlocked is stored in the internal memory of the electronic key 200, and thus the connection terminals come into contact with each other, thereby performing the primary authentication.

Since owning the electronic key 200 is one authentication, it is possible to maintain higher security than the conventional electronic locking device such as a door lock that simply inputs a password. In particular, since such a small electronic locking device has a small volume and needs to be installed in several locations, a method of unlocking the lock while supplying power from the electronic key 200 is very useful because there is no power supply inside the electronic locking device 100.

In this case, in order to further enhance security, a secondary authentication means may be added to the electronic key 200. In FIG. 2, four key pads 260 are attached to the electronic key 200, and the secondary authentication may be performed through the key pad 260. For example, numbers such as 1, 2, 3, and 4 are printed on the keypad 260, and the secondary authentication may be performed with a combination thereof.

In order for the user to perform the unlocking with the electronic key 200, a power button of the electronic key 200 is first pressed to turn on the electronic key 200, and then a preset password is input to the keypad 260. When the password input by the user is the same as the password stored in the internal memory of the electronic key 200, the information indicating that the second authentication using the password succeeds is notified through sound or a lamp, and then the double authentication may be performed in a manner that the electronic locking device 100 is unlocked when a user makes the electronic key 200 contact with the electronic locking device 100.

Of course, in FIG. 1, the keypad 260 is shown to aid understanding of the disclosure. In addition, a fingerprint sensor may be added to the electronic key 200, and the authentication using biometric information may be performed using a user's fingerprint. In addition, it is possible to perform the double authentication by adding various sensors to the electronic key 200 and using these sensors.

However, since the electronic key 200 has a limitation in the computational capability and the addition of the sensor due to the limitation of the volume, the communication module such as Bluetooth may be added to the electronic key 200. In addition, the double authentication may be performed using an external device while the electronic key 200 communicates with an external device such as a smartphone.

For example, a user may be authenticated through face recognition using a camera or voice recognition using a microphone on a smartphone. Only when such secondary authentication succeeds, the information indicating that the authentication succeeds with the electronic key 200 on the smartphone may be transmitted. Next, the double authentication may be performed by the method of performing authentication with the contact of the electronic key 200 with the electronic locking device 100. The double authentication enhances the security.

FIG. 4 is a block diagram illustrating a configuration of a user terminal according to an embodiment of the present disclosure.

Referring to FIG. 4, the user terminal 400 may include an input unit 410, a display unit 420, a communication unit 430, a storage unit 440, and a control unit 450.

The input unit 410 converts a user's input operation into an input signal and transmits the input signal to the control unit 450. The input unit 410 may be implemented as, for example, a keyboard, a mouse, a touch sensor on a touch screen, a touch pad, a keypad, a voice input, and other input processing devices that are possible in the present, in the past, or in the future.

The display unit 420 outputs a screen under the control of the control unit 450. The display unit 420 may be implemented as, for example, a liquid crystal display (LCD), a light emitting diode (LED), an organic light emitting diode (OLED), a projector, and other display devices that are possible in the present, in the past, or in the future. The display unit 420 may display, for example, an interface page for providing information or an information providing result page. According to the embodiment, a component that uses other methods of transmitting information such as voice output or vibration instead of the screen output to other users may be used instead of the display unit 420.

The communication unit 430 exchanges data with the management server 500 and/or the electronic key 200.

In an embodiment, the communication unit 430 transmits the one-time authentication ID received from the management server 500 to the control unit 450. In addition, the communication unit 430 transmits data to the management server 500 under the control of the control unit 450. The communication technology used by the communication unit 430 may vary depending on the type of communication network or other circumstances. The communication unit 430 may communicate with the electronic key 200 through a first communication network, and communicate with the management server 500 through a second communication network.

The storage unit 440 stores data under the control of the control unit 450 and transmits the requested data to the control unit 450.

The control unit 450 controls the overall operation of the user terminal 400 and each component.

When the user terminal 400 transmits and receives data, it may be expressed that the communication unit 430 transmits and receives data under the control of the control unit 450 according to the viewpoint, and it may be expressed that the control unit 450 controls the communication unit 430 to transmit and receive data.

In particular, the control unit 450 may transmit the one-time authentication ID request message to the management server 500 according to the information input from the input unit 410.

In addition, the control unit 450 may transmit the one-time authentication ID received from the management server 500 to the electronic key 200.

As described above, when the user terminal 400 transmits and receives data, it may be expressed that the communication unit 430 transmits and receives data under the control of the control unit 450 according to the viewpoint, and it may be expressed that the control unit 450 controls the communication unit 430 to transmit and receive data.

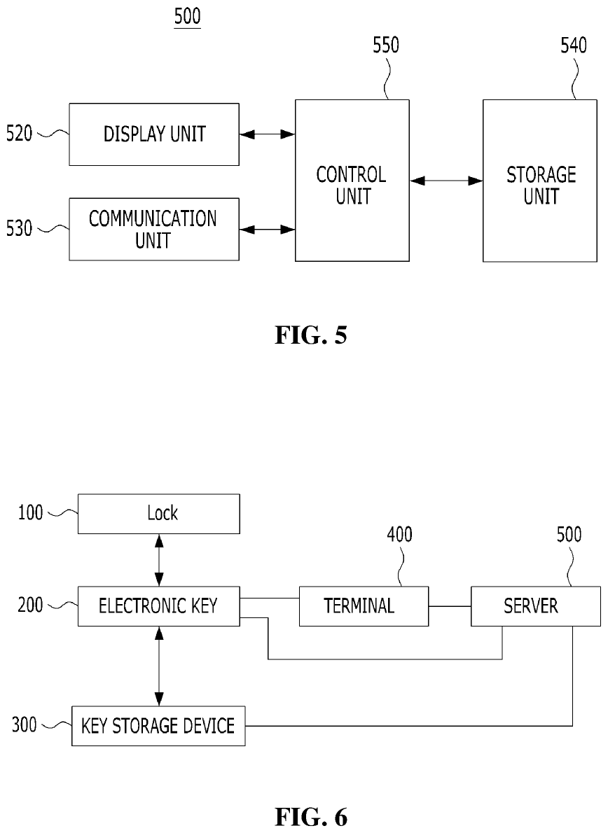

FIG. 5 is a block diagram illustrating a configuration of a management server according to an embodiment of the present disclosure.

Referring to FIG. 5, the management server 500 may include a display unit 520, a communication unit 530, a storage unit 540, and a control unit 550. In an embodiment of the present disclosure, it is disclosed that the management server includes the display unit 520, the communication unit 530, the storage unit 540, and the control unit 550, but some of these may be implemented as physically distinguished devices. For example, the display unit 520 may be implemented as a separate monitor or an external terminal such as a manager terminal.

The display unit 520 outputs the screen under the control of the control unit 550.

The display unit 520 may be implemented as, for example, a liquid crystal display (LCD), a light emitting diode (LED), an organic light emitting diode (OLED), a projector, and other display devices that are possible in the present, in the past, or in the future. The display unit 520 may display, for example, the interface page for providing the information or the information providing result page. According to the embodiment, the component that uses other methods of transmitting information such as voice output or vibration instead of the screen output to other users may be used instead of the display unit 520.

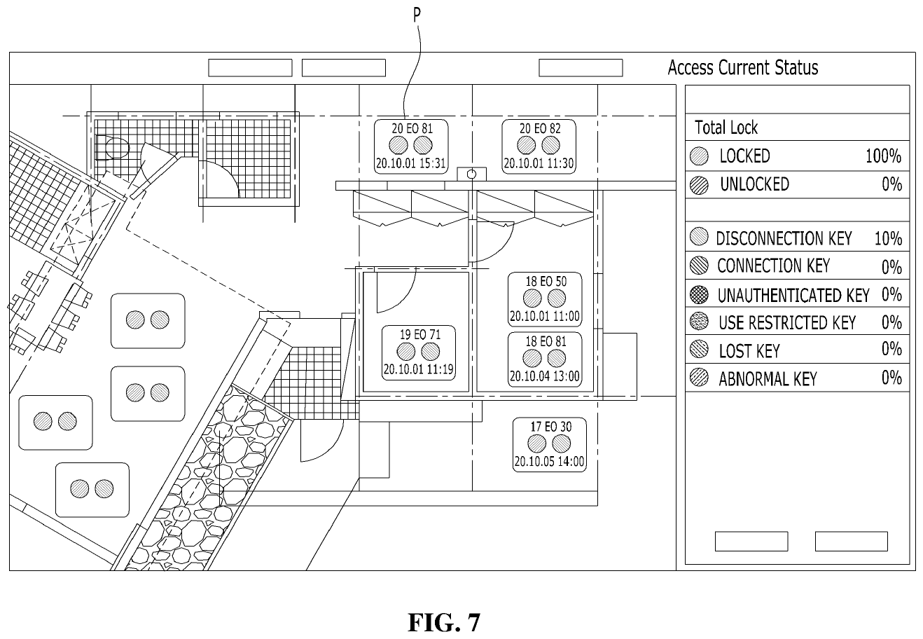

As in the description with reference to FIG. 7 to be described later, the display unit 520 may display the pre-stored location of the electronic locking device 100 on a map. The display unit 520 displays the location of the electronic locking device 100 and the current state (including the charging state, the connection state, and the like of the electronic key) of the electronic locking device 100 on the map in real time. The display unit 520 may display the location of the locking device on the map in different colors according to the current state. Accordingly, the user may intuitively grasp the location and current state of the locking device by checking the map.

The communication unit 530 exchanges data with the user terminal 400 and/or the electronic key 200.

In an embodiment, the communication unit 530 receives log information from the electronic key 200 and/or the user terminal 400 and transmits the log information to the storage unit 540.

In an embodiment, the communication unit 530 may receive one-time authentication request information from the electronic key 200 and/or the user terminal 400 to transmit the received one-time authentication request information to the control unit 550. The communication technology used by the communication unit 530 may vary depending on the type of communication network or other circumstances.

The storage unit 540 stores data under the control of the control unit 550 and transmits the requested data to the control unit 550.

The control unit 550 controls the overall operation of the management server 500 and each component. In particular, as described later, the control unit 550 may transmit the one-time authentication ID request message to the management server 500 according to the information input from the input unit (not illustrated), and transmit the one-time authentication ID received from the management server 500 to the electronic key 200.

When the control unit 550 receives a signal from the electronic key 200 without the unlocking authority that is put into the electronic locking device 100 and electrically contacts with the electronic locking device 100, the control unit 550 displays the location of the corresponding electronic locking device 100 on the display device. Here, the absence of the unlocking authority means the electronic key that does not have the UID corresponding to the electronic locking device 100. In this way, the location of the electronic locking device 100 into which the electronic key 200 without the unlocking authority is put is displayed differently from the location of the electronic locking device 100 into which the electronic key 200 is not put. For example, the location of the electronic locking device 100 to which the electronic key 200 is not put is indicated in black. The location of the electronic locking device 100 into which the electronic key 200 without the unlocking authority is put may be indicated in red. The one-time authentication may be performed by selecting (clicking the mouse or touching the touch panel) the electronic locking device 100 indicated in red. That is, the control unit 550 generates the one-time authentication ID for the selected electronic locking device 100 and the one-time authentication data, and transmits the generated one-time authentication ID and one-time authentication data to the electronic key 200 and the electronic locking device 100 through the communication unit 530.

Data for the one-time authentication is implemented such that the authentication authority disappears when the corresponding electronic locking device 100 and the electronic key 200 are separated. For example, the one-time authentication ID and one-time authentication data stored in the electronic key 200 and the electronic locking device 100 may be implemented to be deleted after one-time authentication.

In another embodiment, the control unit 550 may set the authority for the authentication stored in the electronic key 200.

The control unit 550 may transmit information for setting any one or more of a date, a time, and a day of the week of the electronic key 200 to the electronic key 200 directly or through the user terminal 400 according to the input through the input unit (not illustrated) for setting the authentication authority. Accordingly, the electronic key 200 may enable the electronic key to be activated only when the authority is set.

FIG. 6 is a block diagram schematically illustrating a configuration of an electronic key management system according to another embodiment of the present disclosure.

The electronic key management system may include the electronic locking device 100, the electronic key 200, the electronic key storage device 300, the user terminal 400, and the management server 500.

Since the electronic key 200, the user terminal 400, and the management server 500 are the same as those described in FIG. 1, a detailed description thereof will be omitted.

The electronic locking device 100 includes not only drawers, cabinets, storage boxes, and safes, but also CCTV or traffic signal control panel doors, communication company's repeater enclosure doors, communication base stations, entrance doors of police station/military unit/armory/ammunition locker, an ARM device, a lading box logistics vehicle, and the like.

Such an electronic locking device 100 does not have a separate power source, and temporarily receives power from the connection terminal (not illustrated) of the electronic key 200 through the connection terminal (not illustrated), thereby unlocking the electronic locking device 100. In this case, the connection terminal of the electronic locking device 100 and the connection terminal of the electronic key 200 may be in physical contact with each other to supply power as well as exchange identifiers (UIDs) of each other, thereby performing the authentication.

Since such a small electronic locking device has a small volume and needs to be installed in several locations, the electronic locking device 100 does not have a power supply provided therein, and the method of unlocking an electronic locking device 100 while receiving power from the electronic key 200 is very useful.

The electronic key storage device 300 may transmit and receive information through the communication network with the management server 500. For example, the electronic key storage device 300 may transmit the history of the electronic key inserted into the key hole to be described later and/or the charging information of the fastened electronic key to the management server 500 in real time. In addition, the electronic key storage device 300 may receive the access authority information on the electronic locking device for each electronic key or may download firmware update information of the electronic key storage device. The electronic key storage device 300 may notify the management server 500 when it is confirmed that the unlocking attempt is made by the electronic key without the unlocking authority. The management server 500 transmits a message notifying the unlocking attempt without the unlocking authority to the pre-registered terminal when the unlocking attempt is confirmed with the electronic key without the unlocking authority. In this case, the pre-registered terminal may be an administrator or an external terminal registered by the administrator.

The electronic key storage device 300 includes a plurality of key holes and a key holder fastened with the electronic key 200 carried into the key hole.

The electronic key storage device 300 can store the electronic key 200 by inserting the electronic key 200 into each hole. For example, 25 key holes 330 may be provided, but the number of key holes 330 is not limited thereto. When the key is carried into the key hole 330, the electronic key 200 may be charged.

The electronic key storage device 300 also controls the electronic key 200 to be fastened and unfastened with and from the key holder according to the access authority (accessible electronic key/accessible time) to the electronic key 200 set in advance. In addition, the electronic key storage device 300 charges the fastened electronic key 200.

In another embodiment, the electronic key storage device 300 may receive and store the log information from the fastened electronic key 200.

The electronic key storage device 300 may receive the password when releasing the electronic key 200 fastened by the user and withdrawing the electronic key 200, and unfasten the corresponding electronic key 200 only when the input password matches the password stored by matching the corresponding electronic key 200.

In addition, the electronic key storage device 300 may change the color of the state display unit provided around the key holder according to whether the user has the access authority through the password authentication. For example, the state display unit 340 around the key hole 330 that matches the key available to the user may be displayed in blue, and the state display unit 340 around the key hole 330 matching the key that is not available may be displayed in red. This makes it possible to easily identify a key that a user may use and a key hole to be returned.

In addition, when the pre-stored password is input, the electronic key storage device 300 may output the information on the location of the key hole with which the electronic key 200 matching the input password is fastened. For example, it is possible to turn on the LED provided in the location of the key hole.

The electronic key storage device 300 may further display the charging state through the state display unit. For example, when the electronic key 200 is being charged, when the charging is completed, the state may be guided to the user in color by distinguishing reading/writing of data, and the like.

FIG. 7 is a diagram illustrating an example of a screen displayed by the management server according to the embodiment of the present disclosure.

Referring to FIG. 7, the management server displays the locations of a plurality of electronic locking devices on a map.

Each electronic locking device reflects and displays the current state in real time. Each of the electronic locking devices displays whether or not an electronic key is put and electrically connected to the electronic locking device. The state may be displayed differently in color and/or image. For example, the state in which the electronic key is connected may be displayed in red, and the state in which the electronic key is not connected may be displayed in blue. In addition, the management server may further display statistical information according to the pre-stored state of the electronic locking device in a separate area. For example, the number of electronic locking devices in the locked state, the number of electronic locking devices in the unlocked state, the number of electronic locking devices to which the electronic key is connected, and the number of electronic locking devices to which the blacklist electronic key is connected may each be displayed.

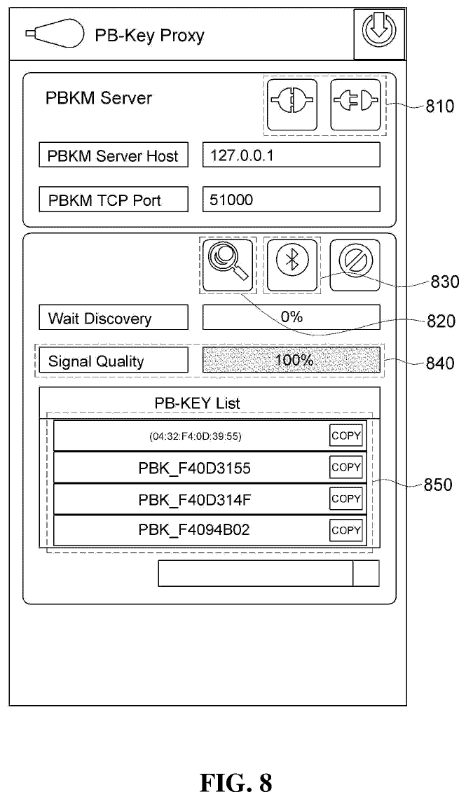

FIG. 8 is a diagram illustrating an example of a screen displayed by the user terminal according to the embodiment of the present disclosure.

Referring to FIG. 8, the user terminal may include a connection information display unit 810 with a server, a discovering button 820, a pairing button 830, a signal quality display unit 840, and a key list 850 on the display screen.

The access information display unit 820 displays the screen that displays the connection status with the management server by selecting and changing the connection and disconnection with the server each time the screen is clicked. When the connection state with the server is changed, the state change is displayed in color or the like. For example, when the connection succeeds, the button may be displayed in blue.

The discovering button 820 is a button for selecting a search for an electronic key in a communication range that is not initially connected to the user terminal and the electronic key. When the discovering button 820 is selected, the list of electronic keys in the communication range is displayed on the key list 850.

The pairing display unit 830 is a button for instructing the electronic key to be paired with the selected electronic key among the electronic keys displayed on the key list 850.

The signal quality display unit 840 may display the quality of the paired signal.

The key list 850 may display an ID of an electronic key according to a condition selected according to the discovering button 820 and the pairing button 830.

An attempt to carry out the electronic key other than the carrying out date and time of the electronic key of the input electronic key according to this electronic key storage device may be prevented.

In addition, it is possible to systematically manage the electronic keys using the electronic key management system, and easily perform the charging of the electronic keys and the collection of the use history (log information) during the process. In addition, it is possible to easily set and change the authentication authority of the electronic key. In addition, it is possible to easily perform the electronic key management through the UI of the user terminal.

Although the embodiments of the present disclosure has been described with reference to the accompanying drawings, those skilled in the art will appreciate that various modifications and alterations may be made without departing from the spirit or essential feature of the present disclosure. Therefore, it is to be understood that the embodiments described above are illustrative rather than being restrictive in all aspects.

1. An electronic key management system, comprising:
an electronic key configured to lock and unlock an electronic locking device;
an electronic key storage device configured to include a plurality of key holes and a key holder fastened with the electronic key carried into the key hole, and control the key holder according to a preset electronic key access right;
a management server configured to set an access right to the electronic locking device of the electronic key, transmit a one-time authentication ID to the electronic key that is put into the electronic locking device and electrically connected to the electronic locking device, and receive log information of the electronic key on the electronic locking device in real time; and
a user terminal configured to transmit and receive the log information and the one-time authentication ID between the electronic key and the management server, and display real-time log information.

2. The electronic key management system of claim 1, wherein the management server transmits one-time authentication data corresponding to the one-time authentication ID to the electronic locking device through the electronic key.

3. The electronic key management system of claim 1, wherein the management server stores any one or more of location information of the plurality of electronic locking devices and current state information of the electronic locking device, and displays the location information and the current state information through a display unit.

4. The electronic key management system of claim 3, wherein the management server displays locations of the electronic locking devices into which the electronic key without unlocking authority is put on the display unit on which the locations of the plurality of electronic locking devices are displayed, differently from other electronic locking devices.

5. The electronic key management system of claim 4, wherein the management server transmits the one-time authentication ID corresponding to the one-time authentication data to the electronic locking device into which the electronic key without the unlocking authority displayed on the display unit differently from the other electronic locking devices is put and the put electronic key, respectively, when an administrator's approval is input.

6. The electronic key management system of claim 1, wherein the electronic key deletes the one-time authentication ID after receiving the one-time authentication ID and unlocking the electronic locking device.

7. The electronic key management system of claim 1, wherein the management server transmits a message notifying an unlocking attempt without unlocking authority from the electronic locking device to at least one of a pre-registered administrator or a pre-registered external terminal when the unlocking attempt by the electronic key without the unlocking authority is confirmed.

8. An electronic key management server, comprising:
a communication unit configured to transmit and receive an electronic key and information;
a storage unit configured to store log information received from the electronic key; and
a control unit configured to set an access right to an electronic locking device of the electronic key, and set a one-time authentication authority for the electronic key that is put into the electronic locking device and electrically connected to the electronic locking device,
wherein the control unit controls to transmit a one-time authentication ID generated according to the one-time unlocking authority setting to the electronic key.

9. The electronic key management system of claim 8, wherein the storage unit stores locations of a plurality of electronic locking devices, and
further includes a display unit for displaying at least one of current state information of the electronic locking device received through the communication unit and a location of the electronic locking device.

10. The electronic key management system of claim 8, wherein the control unit sets an authentication authority of the electronic key, and
the authentication authority includes at least one of a date, a time, and a day of the week in which authentication execution is possible.

11. The electronic key management system of claim 8, wherein the control unit transmits one-time authentication data corresponding to the one-time authentication ID to the electronic locking device through the electronic key.
